(19) United States
(12) Patent Application Publication
(10) Pub. No.: US 2010/0230556 A1
(43) Pub. Date: Sep. 16, 2010

(54) Wrist saver

(76) Inventor: Gitan Mayer, Chilliwack (CA)

Correspondence Address: Thien Tran/ Access Patent Group, LLC, 7706 Tanner Robert Court, Springfield, VA, 22153, US

(21) Appl. No.: 12/659,487

(22) Filed: Mar. 10, 2010

Related U.S. Application Data
(60) Provisional application No. 61/159,024, filed on Mar. 10, 2009.

(51) Int. Cl. F16M 13/00

(52) U.S. Cl. 248/118

(57) ABSTRACT

A wrist saver for a laptop computer having a monitor screen, a base housing, a keyboard on the base housing and a centered mouse pad on the base housing. The wrist saver includes a four rounded corners rectangular wrist pad having an optimal height between two to three millimeters, so that the monitor screen of the laptop computer can be closed without damage thereto. A structure is for retaining the wrist pad onto a top surface of the base housing in front of the keyboard, between the centered mouse pad and an edge of the base housing. An antimicrobial protective surface is formed on a fabric cover of the pad. The wrist pad will comfortably support a hand of a person using the laptop computer.

### CROSS-REFERENCE TO RELATED APPLICATION

This application claims the benefit of Provisional Patent Application No. 61/159,024, filed on Mar. 10, 2009, In the United States Patent & Trademark Office, the disclosure of which is incorporated herein by reference.

### BACKGROUND OF THE INVENTION

1. Field Of The Invention

The present invention relates to a wrist pad, and more particularly, a wrist saver for a laptop computer.

While using a laptop computer, one's wrist may become strained. Users may often have to take breaks from their work in order to stretch and rest their wrist. Cramping can also occur in one's wrist, which can be painful and aggravating. Those that may use a laptop computer for an extended amount of time may feel this pain and discomfort often, causing displeasure. Having a simple way to cushion one's wrist while using a laptop, may assist many individuals in utilizing their portable laptop computer in a more comfortable manner.

2. Description of the Prior Arts

Numerous innovations for wrist rests have been provided in the prior art that will be described. Even though these innovations may be suitable for the specific individual purposes to which they address, however, they differ from the present invention.

A FIRST EXAMPLE, U.S. Patent Office Document No. 5,451,020, Issued on Sep. 19, 1995, to Smith et al. teaches a wrist rest of specially designed height and other characteristics for reducing strain on the wrists and hands of a keyboard operator or a similar user of computer accessories. The rest is made to be placed in front of the keyboard or accessory being used, and may be designed to have a particular firmness for comfort. In some embodiments the rest has two foam rubber layers about ¾ inch thick total; the bottom surface has no “skin”, to prevent the rest from slipping, while the upper surface has a smooth covering so hands may slide around easily and comfortably. In order to allow rests designed for a normal keyboard to be adapted for use with an especially long keyboard, or with an accessory like a mouse pad, one embodiment of the invention has contours which can interlock with similar contours on an extension pad; these contours are also designed to be easily and inexpensively manufactured.

A SECOND EXAMPLE, U.S. Patent Office Document No. 5,562,270, Issued on Oct. 8, 1996, to Montague teaches a device which uses a wrist rest in combination with a computer mouse pad to provide a non-fatiguing environment for manipulation of a computer mouse to control the cursor on a computer display. The wrist rest is designed to place the wrist of the hand manipulating the mouse at a level to provide maximum comfort. The height allows movement of the mouse without a continuous upward bend of the wrist and with movement of the hand that does not cause tension in the arm, neck and shoulder muscles. The wrist rest is also configured in a keyboard/keypad version such that the hand is elevated relative to the keys to be actuated thus relieving tension. The wrist rest and pad are made of a suitable material that does not breakdown under pressure of continuous use yet provides fluid-like pressure distribution for the wrist. The wrist rest and pad may also be used with a protective cover. The wrist rest may have removable cushions which are suitable for use in exercises and the base can have a recession for holding an exercise instruction card which aids in preventing injuries such as carpal tunnel syndrome caused by repetitive motion work.

A THIRD EXAMPLE, U.S. Patent Office Document No. 5,566,913, Issued on Oct. 22, 1996, to Prokop teaches an improved wrist rest for reducing repetitive motion strain injuries on the wrists of a typist or computer keyboard operator. Wrist rest is located in front of and parallel to a keyboard or other typing device such that the wrist or wrists of a user is (are) positioned directly over the wrist rest while typing. Wrist rest consists of an elastic envelope filled with a gelatinous material which provides cushioned support for a user's wrists while maintaining the wrist or wrists in a relatively straight position. In some embodiments the gelatinous material can be chilled or heated to provide a source of cold or heat for a period of time. The gelatinous material can be held in place by a base support means. In some embodiments wrist rest can be grasped with both hands and squeezed, propelling the gelatinous material within the elastic envelope, thereby functioning as an exercise means for the hands and fingers of the hands.

A FOURTH EXAMPLE, U.S. Patent Office Document No. 5,628,483, Issued on May 13, 1997, to Smith et al. teaches a wrist rest of specially designed height and other characteristics for reducing strain on the wrists and hands of a keyboard operator or a similar user of computer accessories. The rest is made to be placed in front of the keyboard or accessory being used, and may be designed to have a particular firmness for comfort. In some embodiments the rest has two foam rubber layers about ¾ inch thick total; the bottom surface has no “skin”, to prevent the rest from slipping, while the upper surface has a smooth covering so hands may slide around easily and comfortably. In order to allow rests designed for a normal keyboard to be adapted for use with an especially long keyboard, or with an accessory like a mouse pad, one embodiment of the invention has contours which can interlock with similar contours on an extension pad; these contours are also designed to be easily and inexpensively manufactured.

A FIFTH EXAMPLE, U.S. Patent Office Document No. 5,678,800, Issued on Oct. 21, 1997, to Markussen teaches an ergonomically designed computer mouse pad for use with a hand operated computer mouse that includes an inclined work surface for supporting the computer mouse. The mouse pad is symmetric so that it can be used with either the right hand or the left hand. During operation, the computer mouse is positioned on the inclined surface and the user's hand is positioned with the palm of the hand on top of the computer mouse so that the user's hand is positioned at an angle relative to the table supporting the mouse pad. The angled position of the hand creates ergonomic benefits such as reducing the muscular and skeletal strain on the user's hand and wrist. In addition, two inclined side surfaces adjacent the inclined work surface ensures that the user's hand and wrist does not rest on an abrupt edge.

A SIXTH EXAMPLE, U.S. Patent Office Document No. 6,767,605, Issued on Jul. 27, 2004, to Raciborski teaches a mouse pad having support for the user's wrist. A pad platform is surrounded with a peripheral wrist support comprising a tubular element filled with a mobile fill media, such as a plurality of pellets. The tubular elements extends above the pad platform sufficiently so that the user's wrist is supported, thereby substantially lessening fatigue over long periods of use.

A SEVENTH EXAMPLE, U.S. Patent Office Publication No.

20050121562, Published on Jun. 9, 2005, to Baumgardner teaches a portable wrist resting pad for relieving and alleviating the strain and fatigue to the wrist and arm from repetitive and continual use of a computer mouse and keyboard includes a first support member for disposition on the desk surface, a second support member mounted to the first support member and having a density less than the first support member, and a wrist strap that extends outwardly from opposite ends of the support members for encompassing the wrist and attaching the support pad to the wrist. The wrist support pad elevates the wrist the appropriate distance from the work surface to relieve strain and fatigue to the wrist and arm for preventing carpal tunnel syndrome; and preferably one wrist support pad should be secured to each wrist to obtain maximum benefit from the portable wrist rest pads.

AN EIGHTH EXAMPLE, U.S. Patent Office Document No. 6,936,022, Issued on Aug. 30, 2005, to Root teaches a system and method to support the forearms, wrists and hands of a user performing repetitive tasks. A support pad has a low-friction upper surface. A cradle is attached to each of the user's wrists. A first portion of a cradle supports the lower portion of the forearm, including the wrist, when the first portion rests upon the upper surface of the support pad. A second portion of each cradle supports the hand of the user. A retaining device attaches the cradle to the lower forearm. The low-friction upper surface advantageously comprises neoprene material (e.g., wetsuit material). The system and method reduce strains on the arms and shoulders of the user by supporting the user's arms and hands while the user performs the repetitive tasks.

A NINTH EXAMPLE, U.S. Patent Office Publication No. 20060226305, Published on Oct. 12, 2006, to Sheybani teaches a wristband for use with a keyboard or mouse (or other applications). The wristband is provided with a padded area formed of foam, beads, or other materials, so as to rest beneath the wrist of the user. A strap is provided to attach the padded portion to the user's wrist such that the padded portion rests beneath the wrist of the user so as to elevate the wrist, reduce strain and the like. Several embodiments were disclosed, including a simple embodiment with an integral VELCRO wristband and simple foam padding. More elaborate versions included a beanbag type pad with a rubber base, and an integral version made from, (for example) fabric coated neoprene rubber (e.g., wetsuit material).

It is apparent now that numerous innovations for wrist rests have been provided in the prior arts that are adequate for various purposes. Furthermore, even though these innovations may be suitable for the specific individual purposes to which they address, accordingly, they would not be suitable for the purposes of the present invention as heretofore described.

### SUMMARY OF THE INVENTION

AN OBJECT of the present invention is to provide a wrist saver that avoids the disadvantages of the prior arts.

ANOTHER OBJECT of the present invention is to provide a wrist saver that is simple and inexpensive to manufacture.

STILL ANOTHER OBJECT of the present invention is to provide a wrist saver that is simple to use.

BRIEFLY STATED, STILL YET ANOTHER OBJECT of the present invention is to provide a wrist saver for a laptop computer having a monitor screen, a base housing, a keyboard on the base housing and a centered mouse pad on the base housing. The wrist saver includes a four rounded corners rectangular wrist pad having an optimal height between two to three millimeters, so that the monitor screen of the laptop computer can be closed without damage thereto. A structure is for retaining the wrist pad onto a top surface of the base housing in front of the keyboard, between the centered mouse pad and an edge of the base housing. An antimicrobial protective surface is formed on a fabric cover of the pad. The wrist pad will comfortably support a hand of a person using the laptop computer.

The novel features which are considered characteristic of the present invention are set forth in the appended claims. The invention itself, however, both as to its construction and its method of operation, together with additional objects and advantages thereof, will be best understood from the following description of the specific embodiments when read and understood in connection with the accompanying drawing.

### BRIEF DESCRIPTION OF THE DRAWINGS

The figures of the drawings are briefly described as follows:

FIG. 1 is a perspective view showing the present invention in use with a laptop computer and a wrist resting on it;

FIG. 2 is a top view of the present invention;

FIG. 3a is a side view of the present invention; and

FIG. 3b is an enlarged cross sectional view taken on line 3b-3b in FIG. 3a.

### REFERENCE NUMERALS UTILIZED IN THE DRAWINGS

110 wrist saver
112 laptop computer
113 monitor screen of laptop computer 112
114 base housing of laptop computer 112
116 keyboard of laptop computer 112
118 centered mouse pay of laptop computer 112
120 wrist pad of wrist saver 110
122 retaining structure of wrist saver 110
124 top surface of base housing 114
126 edge of base housing 114
128 hand of person
130 compressible hollow inner component of wrist pad 120
132 gel mold of wrist pad 120
134 fabric cover of wrist pad 120
136 soft plastic material of compressible hollow inner component 130
138 antimicrobial protective surface on fabric cover 134
140 plate of retaining structure 122
142 top surface of plate 140
144 adhesive layer of retaining structure 122
146 bottom surface of plate 140
148 non-slip peel away cover strip of retaining structure 122

### DETAILED DESCRIPTION OF THE PREFERRED EMBODIMENT

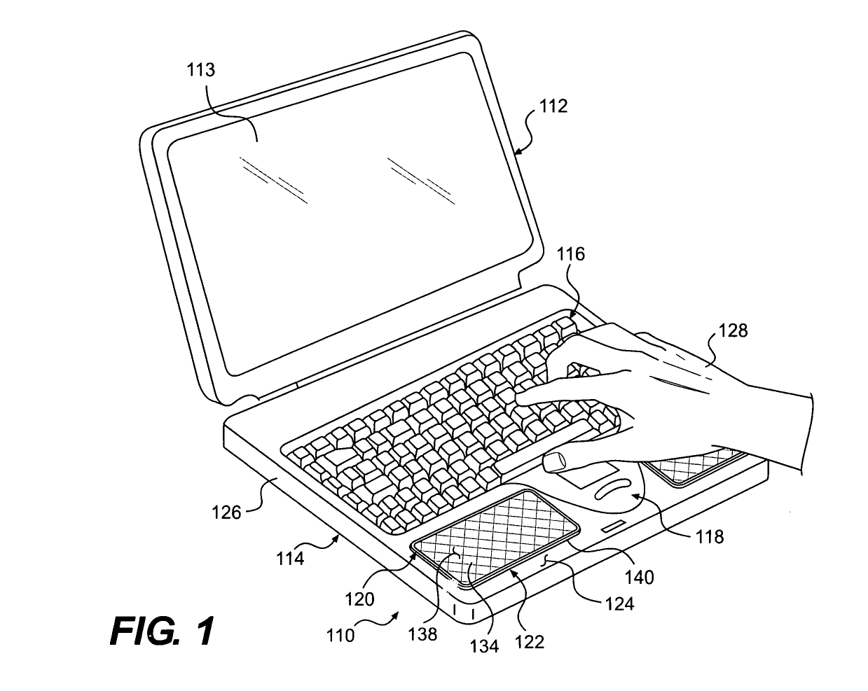

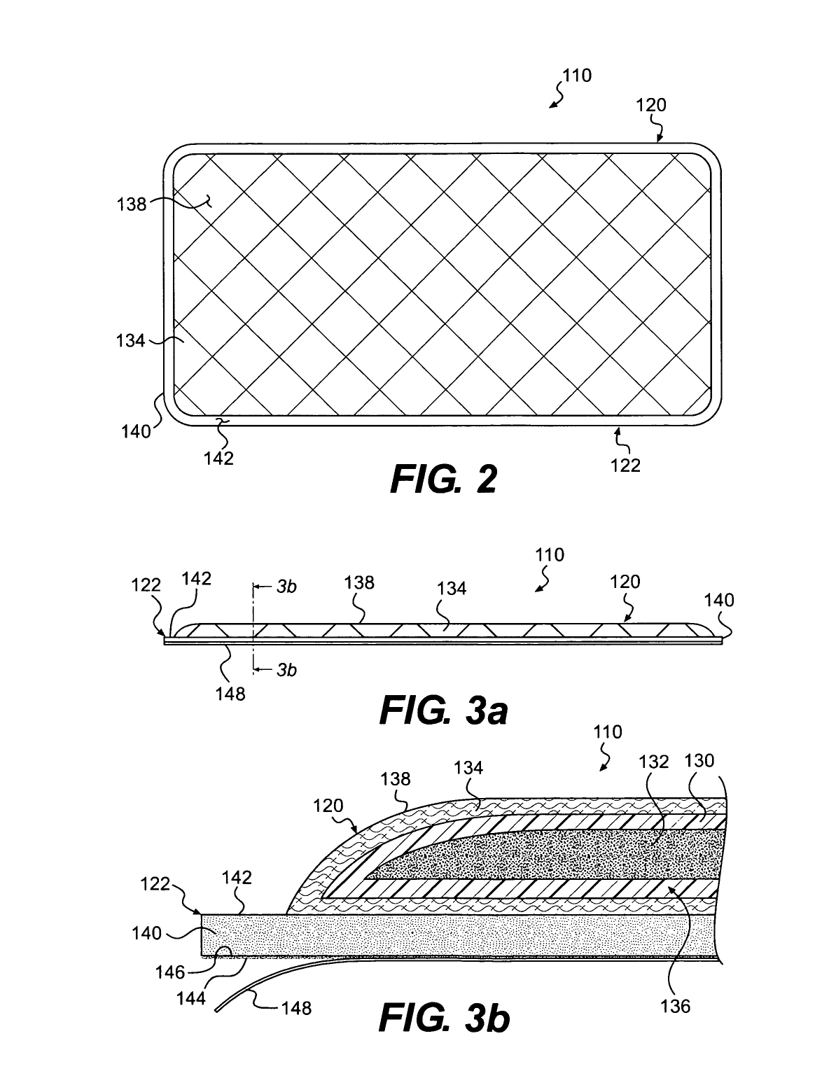

Referring now to the figures, in which like numerals indicate like parts, and particularly to FIGS. 1 through 3, and as such, will be discussed with reference thereto.

The present invention is a wrist saver 110 for a laptop computer 112 having a monitor screen 113, a base housing 114, a keyboard 116 on the base housing 114 and a centered mouse pad 118 on the base housing 114. The wrist saver 110 comprises a wrist pad 120 having an optimal height or thickness between two to three millimeters, so that the monitor screen 113 of the laptop computer 112 can be closed without damage thereto. A structure 122 is for retaining the wrist pad 120 onto a top surface 124 of the base housing 114 in front of the keyboard 116, between the centered mouse pad 118 and an edge 126 of the base housing 114. The wrist pad 120 will comfortably support hand 128 of a person using the laptop computer 112.

The wrist pad 120 comprises a compressible hollow inner component 130. A gel mold 132 is carried within the compressible hollow inner component 130. A fabric cover 134 extends about the compressible hollow inner component 130. The compressible hollow inner component 130 is fabricated out of a soft plastic material 136. The fabric cover 134 is coated with an antimicrobial protective surface 138, making said fabric cover 134 easier to clean and withstand daily wear and tear of everyday use.

The wrist pad 120 is generally rectangular in shape with four rounded corners. The retaining structure 122 comprises a plate 140 having a top surface 142 affixed to bottom of the wrist pad 120. An adhesive layer 144 is applied onto a bottom surface 146 of the plate 140 to permanently secure the wrist pad 120 in place. The retaining structure 122 further comprises a non-slip peel away cover strip 148 on the adhesive layer 144 to allow the wrist pad 120 to be held in a stationary position and be removed when needed. The wrist pad 120 is sized two inches wide and between two to four inches length, so that two of the wrist pads 120 can each be located on an opposite side of the centered mouse pad 118, if the person wants to rest both left and right wrists over the base housing 114.

The wrist pad 120 is made with the fabric cover 134 fabricated out of a soft, durable jersey material. The wrist pads 120 could either be sold individually or in packs, such as one pack with different sized wrist pads 120 or one pack with the same size wrist pads 120.

The wrist saver 110 provides consumers with additional wrist support while utilizing the laptop computer 112. This unique product allows a person's wrist to remain comfortable for an extended period of time while resting against the base housing 114 of the laptop computer 112. This innovative item is ideal for students, researchers, writers and anyone else looking for a simple and compact way to make using the laptop computer 112 a more pleasurable and comfortable experience.

It will be understood that each of the elements described above, or two or more together, may also find a useful application in other types of constructions differing from the types described above.

While the invention has been illustrated and described as embodiments of a wrist saver, accordingly it is not limited to the details shown, since it will be understood that various omissions, modifications, substitutions and changes in the forms and details of the device illustrated and its operation can be made by those skilled in the art without departing in any way from the spirit of the present invention.

Without further analysis, the foregoing will so fully reveal the gist of the present invention that others can, by applying current knowledge, readily adapt it for various applications without omitting features that, from the standpoint of prior art, fairly constitute characteristics of the generic or specific aspects of this invention.

The invention claimed is:

1. A wrist saver for a laptop computer having a monitor screen, a base housing, a keyboard on the base housing and a centered mouse pad on the base housing, said wrist saver comprising:
a) a wrist pad having an optimal height between two to three millimeters, so that the monitor screen of the laptop computer can be closed without damage thereto; and
b) means for retaining said wrist pad onto a top surface of the base housing in front of the keyboard, between the centered mouse pad and an edge of the base housing, wherein said wrist pad will comfortably support a hand of a person using the laptop computer.

2. The wrist saver as recited in claim 1, wherein said wrist pad comprises:
a) a compressible hollow inner component;
b) a gel mold carried within said compressible hollow inner component; and
c) a fabric cover extending about said compressible hollow inner component.

3. The wrist saver as recited in claim 2, wherein said compressible hollow inner component is fabricated out of a soft plastic material.

4. The wrist saver as recited in claim 2, wherein said fabric cover is coated with an antimicrobial protective surface, making said fabric cover easier to clean and withstand daily wear and tear of everyday use.

5. The wrist saver as recited in claim 1, wherein said wrist pad is generally rectangular in shape with four rounded corners.

6. The wrist saver as recited in claim 1, wherein said retaining means comprises:
a) a plate having a top surface affixed to bottom of said at least one wrist pad; and
b) an adhesive layer applied onto a bottom surface of said plate to permanently secure said wrist pad in place.

7. The wrist saver as recited in claim 6, wherein said retaining means further comprises a non-slip peel away cover strip on said adhesive layer to allow said wrist pad to be held in a stationary position and be removed when needed.

8. The wrist saver as recited in claim 1, wherein said wrist pad is sized two inches wide and between two to four inches length, so that two of said wrist pads can each be located on an opposite side of the centered mouse pad, if the person wants to rest both left and right wrists over the base housing.
